(19) United States
(12) Patent Application Publication
(10) Pub. No.: US 2011/0148857 A1
(43) Pub. Date: Jun. 23, 2011

(54) FINDING AND SHARING OF DIGITAL IMAGES BASED ON SHARED FACE MODELS

(75) Inventors: Eyal Krupka, Shimshit, (IL); Igor Abramovski, Haifa (IL)

(73) Assignee: MICROSOFT CORPORATION, Redmond, WA (US)

(21) Appl. No.: 12/646,606

(22) Filed: Dec. 23, 2009

(51) Int. Cl. G06T 15/00; G06K 9/54

(52) U.S. Cl. 345/419; 382/305

(57) ABSTRACT

Systems and methods are described herein for finding and sharing digital images of a user, such as digital photographs of the user, that are located in collections of digital images belonging to others. In accordance with at least one implementation, a face model of a first user is built using a first user computer, wherein the face model is built based on digital images of the first user stored on or accessible to the first user computer. The face model of the first user is then made accessible to a second user computer for use by the second user computer in finding digital images of the first user stored on or accessible to the second user computer. The digital images found by the second user computer are then made accessible to the first user computer.

### BACKGROUND

Advances in digital photography and personal computing have enabled users to maintain albums of digital photographs (also referred to herein as “digital photos” or simply “photos”) that reside on or are otherwise accessible to the users via a computer or other processor-based system or device. Advances in networking and data storage have also made it possible for users to share digital photos with others, such as friends or family. For example, digital photos can be shared with others via e-mail, via online photograph sharing services, via social networking Web sites, via the transfer of portable storage media such as USB flash drives, or by other means.

A user is often interested in seeing digital photos of himself/herself. To find such photos among the user's own albums can be a daunting task if the volume of photos stored in such albums is large. To address this issue, software applications have been developed that utilize face recognition functionality to assist the user in finding photos of himself/herself in the user's albums. For example, the PICASA™ software application, which is published by Google, Inc. of Mountain View, Calif., allows a user to browse through his/her photos and tag his/her face when it appears in such photos. The tagged photos are then used to build a face model that is used by the face recognition functionality to identify other photos of the user in the user's albums. The PICASA™ software application also allows a user to tag faces of others (e.g., the faces of friends and family members) to build face models for locating pictures of others in the user's albums.

Often, there are photos of a user that reside in albums belonging to others to which the user has no access. For example, photos of the user may reside in albums belonging to a friend. In order for the user to obtain such photos, the friend must either share all the photos in the friend's albums, which may not be practical or desirable, and then the user must search through the shared photos to find photos of himself/herself. Alternatively, the friend may agree to search among the friend's albums to identify photos of the user and then share such photos with the user once they are found. The latter approach can be burdensome for the friend, particularly if the friend has a large number of photos in his/her albums.

It is possible that the friend can use a software application such as PICASA™ to identify photos of the user in the friend's albums for sharing. However, this still requires the friend to go through the manual process of tagging the user's face in the friend's photos so that the software application can build a face model. Furthermore, since the number of photos of the user located in the friend's albums may be relatively small, it is possible that the face model generated by the software application will not be very accurate. If a face model is not accurate, then the software application may erroneously include photos that do not show the user among the photos identified as showing the user. This can be a frustrating experience for the friend, who is then required to sort through valid and invalid photos selected by the software application. Also, if the face model is not accurate, then the software application may erroneously fail to include photos that actually do show the user among the photos identified as showing the user. Additionally, when the friend adds new photos to the friend's albums, the friend must manually execute a new search for photos of the user in order to enable sharing of such photos with the user.

What is needed then is a system and method for finding and sharing digital images of a user and his/her family members that are located in albums belonging to others, such as albums belonging to friends and family of the user, that addresses one or more of the shortcomings associated with conventional approaches as described above.

### SUMMARY

Systems and methods are described herein for finding and sharing digital images of a user and his/her family members, such as digital photographs of the user, that are located in collections of digital images belonging to others. In accordance with at least one implementation, a face model of a first user is built using a first user computer, wherein the face model is built based on digital images of the first user stored on or accessible to the first user computer. The face model of the first user is then made accessible to a second user computer for use by the second user computer in finding digital images of the first user stored on or accessible to the second user computer. The digital images found by the second user computer are then made accessible to the first user computer.

The foregoing approach to finding and sharing digital images is advantageous in that it allows a superior face model to be built of a first user on a first user computer that is most likely to have access to reference images of the first user. This superior face model is then shared among other user computers. The foregoing approach to finding and sharing digital images is also advantageous in that it allows a second user of the second user computer to search for digital images of the first user that are located on or accessible to the second user computer using the superior face model. The foregoing approach to finding and sharing digital images is further advantageous in that it allows the first user to obtain digital images of himself/herself that are located in collections of digital images belonging to others in a manner that requires only a relatively small amount of effort as compared to conventional approaches. The foregoing approach to finding and sharing digital images is still further advantageous in that it can be implemented across a large number of user computers, thereby facilitating image finding and sharing among a large number of related and unrelated users in a manner that is both reliable and user-friendly. Further advantages of the foregoing approach to the finding and sharing of digital images will be described herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of a system that facilitates the finding and sharing of digital images of a first user that are located in collections of digital images belonging to or maintained by other users.

FIG. 2 is a block diagram of an example implementation of an image finding/sharing module which may be installed on a user computer.

FIG. 3 depicts a flowchart of a method for finding and sharing digital images of a first user that are located in a collection of digital images belonging to or maintained by another user.

FIG. 4 depicts a flowchart of a face model building process that utilizes a video capture device.

FIG. 5 is a block diagram of the system of FIG. 1, in which an image finding/sharing module has been installed on a second user computer.

FIG. 6 is a block diagram of system in which a method for finding and sharing of digital images is implemented by a plurality of user computers, thereby facilitating image sharing among the plurality of user computers.

FIG. 7 is a block diagram of an example server-based system that facilitates the finding and sharing of digital images of a first user that are located in collections of digital images belonging to or maintained by other users.

FIG. 8 illustrates an example graphical user interface (GUI) that may be used to activate certain digital image finding and sharing features.

FIG. 9 illustrates an example GUI that may be used to facilitate video capture of a user for building a preliminary face model of the user.

FIG. 10 illustrates an example GUI that may be used to select digital images from among a set of preliminary images of a user identified using a preliminary face model of the user.

FIG. 11 illustrates an example GUI that may be used to select one or more contacts with whom to share a face model.

FIG. 12 illustrates an example e-mail that may be automatically generated by a face model sharing module installed on user computer.

FIG. 13 illustrates an example GUI that may be used to selectively share digital images with another user.

FIG. 14 depicts an example computer system that may be used to implement various aspects of the embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Systems and Methods for Finding and Sharing Digital Images Based on Shared Face Models

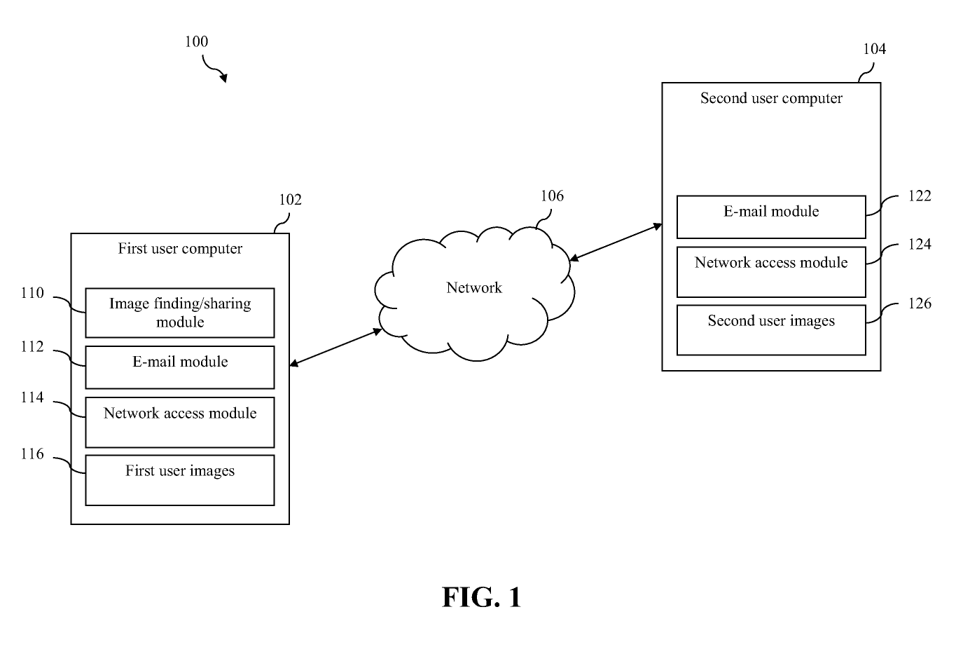

FIG. 1 is a block diagram of a system 100 that facilitates the finding and sharing of digital images of a first user that are located in collections of digital images belonging to or maintained by users other than the first user. As used herein, the term “digital images” may include but is not limited to digital photographs (also referred to as “digital photos” or simply “photos”) as well as digital video files. As shown in FIG. 1, system 100 includes a first user computer 102 and a second user computer 104 that are communicatively connected to each other via a network 106.

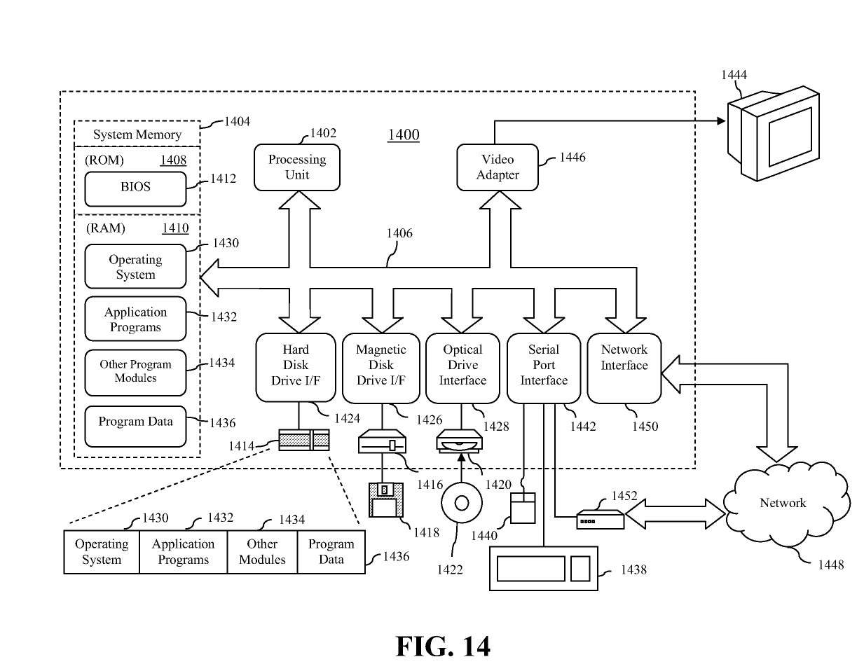

Each of first user computer 102 and second user computer 104 is intended to broadly represent any processor-based computer system or platform upon which software may be executed for the benefit of a user. For example and without limitation, each of first user computer 102 and second user computer 104 may comprise a desktop computer, a laptop computer, a tablet computer, a video game console, a personal digital assistant, a smart phone, or a portable media player. A specific example of a processor-based computer system that may be used to implement either or both of first user computer 102 and second user computer 104 will be described subsequently herein in reference to FIG. 14.

Network 106 is intended to broadly represent any communication path or channel by which data may be transferred between first user computer 102 and second user computer 104. In one embodiment, network 106 comprises a wide area network such as the Internet. However, this example is not intended to be limiting, and network 106 may comprise any type of network or combination of networks including but not limited to wide area networks, local area networks, private networks, public networks, packet networks, circuit-switched networks, and wired or wireless networks.

As further shown in FIG. 1, a number of software modules are installed on first user computer 102 and second user computer 104. With respect to first user computer 102, these software modules include an image finding/sharing module 110, an e-mail module 112, and a network access module 114. With respect to second user computer 104, these software modules include an e-mail module 122 and a network access module 124. First user computer 102 also stores or has access to a collection of first user images 116, while second user computer 104 also stores or has access to a collection of second user images 126.

Image finding/sharing module 110 comprises software that, when executed by first user computer 102, facilitates the finding and sharing of digital images among users, such as among users of first user computer 102 and second user computer 104. The manner in which image finding/sharing module 110 operates will be described in more detail herein.

E-mail module 112 comprises a software module that, when executed by first user computer 102, enables a user of first computer 102 to create and send e-mails as well as receive and review e-mails. By way of example, e-mail module 112 may comprise any of a variety of existing e-mail applications, including but not limited to MICROSOFT® OUTLOOK®, published by Microsoft Corporation of Redmond, Wash., or APPLE® MAIL, published by Apple Computer of Cupertino, Calif., although these examples are not intended to be limiting. E-mail module 122 comprises a software module that, when executed by second user computer 104, provides like functionality to a user of second user computer 104.

Network access module 114 comprises a software module that, when executed by first user computer 102, enables first user computer 102 to communicate with and retrieve content from remote computers via network 106. These functions may be performed on behalf of a user of first computer 102 and/or on behalf of a software module executing thereon. In one embodiment, network access module 114 comprises a Web browser, although this example is not intended to be limiting. In an embodiment in which network access module 114 comprises a Web browser, the Web browser may comprise, for example, any commercially-available or publicly-available Web browser including but not limited to INTERNET EXPLORER® (published by Microsoft Corporation of Redmond, Wash.), MOZILLA® FIREFOX® (published by Mozilla Corporation of Mountain View, Calif.), or SAFARI® (published by Apple Computer of Cupertino, Calif.). Network access module 124 comprises a software module that, when executed by second user computer 104, provides functionality similar to that provided by network access module 114 to second user computer 104.

It is noted that in some alternate implementations, network access module 114 provides e-mail functionality to first user computer 102 by hosting an e-mail client that communicates with an e-mail server over network 106. Such e-mail functionality may be provided instead of or in addition to the e-mail functionality provided by e-mail module 112. In a like fashion, network access module 124 may also provide e-mail functionality to second user computer 104.

First user images 116 comprise a collection of digital images that is owned or maintained by a user of first user computer 102. Depending upon the implementation, first user images 116 may be stored locally with respect to first user computer 102, such as, for example, on a hard disk drive of first user computer 102 or on a memory device that is coupled to first user computer 102 via a port or other suitable interface. First user images 116 may also be stored on a tangible computer-readable medium that can be read by an appropriate drive within first user computer 102, such as a CD, DVD or floppy disk drive. In addition, first user images 116 may not actually reside on first user computer 102, but instead may be stored on a remote server and be made accessible to first user computer 102 via execution of network access module 114 or by some other means. For example, first user images 116 may comprise a collection of digital images that is stored on one or more servers maintained by an online photo-sharing service or social networking Web site. Still further, first user images 116 may be distributed across multiple storage means, such as any of the local and remote storage means described above. First user images 116 may also be organized into one or more albums or libraries.

Second user images 126 comprise a collection of digital images that is owned or maintained by a user of second user computer 104. Depending upon the implementation, second user images 126 may be stored locally with respect to second user computer 104, may reside on a remote server and be made accessible to second user computer 104 via execution of network access module 124 or by some other means, or may be distributed across multiple storage means. Second user images 126 may also be organized into one or more albums or libraries.

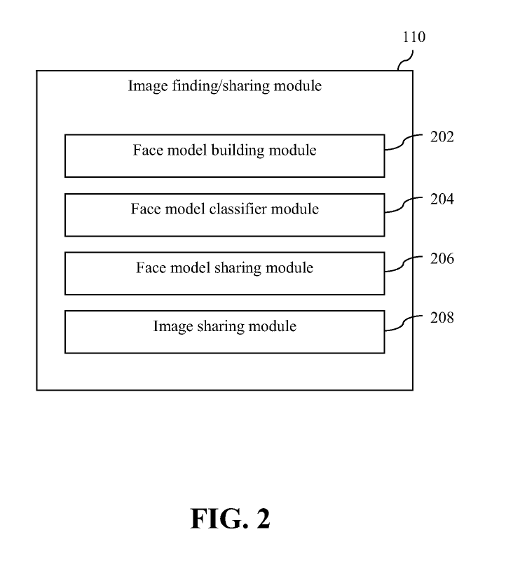

FIG. 2 is a block diagram of an example implementation of image finding/sharing module 110. As shown in FIG. 2, image finding/sharing module 110 includes a plurality of modules including a face model building module 202, a face model classifier module 204, a face model sharing module 206 and an image sharing module 208. Generally speaking, face model building module 202 operates to build a face model of a user of first user computer 102, face model classifier module 204 operates to apply face models of various users to locate desired digital images among first user images 116, face model sharing module 206 operates to share a face model of a user of first user computer 102 with other users, and image sharing module 208 operates to share images located by using face model classifier module 204 with other users. The manner in which these modules operate to perform these functions will be made more apparent from the description provided below.

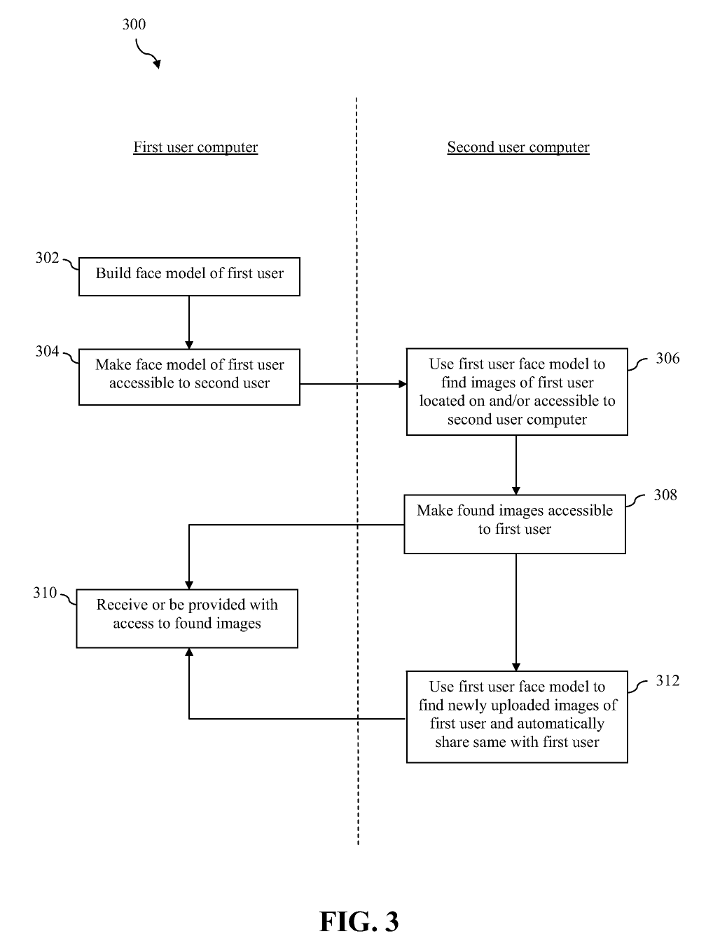

FIG. 3 depicts a flowchart 300 of a method for finding and sharing digital images of a first user that are located in a collection of digital images belonging to or maintained by another user. As shown in FIG. 3, steps of flowchart 300 that are initiated and/or performed by elements executing on first user computer 102 are arranged under the heading “first user computer” and steps of flowchart 300 that are initiated and/or performed by elements executing on second user computer 104 are arranged under the heading “second user computer.” Although the method of flowchart 300 will be described herein in reference to various elements of system 100 as described above in reference to FIGS. 1 and 2, persons skilled in the relevant art(s) will readily appreciate that the method is not limited to that implementation and may be implemented by other systems or elements.

As shown in FIG. 3, the method of flowchart 300 begins at step 302 in which face model building module 202 builds a face model of a user of first user computer 102 (referred to for the purposes of this and subsequent flowcharts as the “first user”). The face model may be built using images of the first user located on and/or accessible to first user computer 102. As will be appreciated by persons skilled in the art of face recognition, a face model comprises a set of features that are representative of a face of a particular person. The type of features that are included in a face model will vary depending upon the modeling technique used. Step 302 may be performed using any of a variety of techniques known in the art or subsequently developed for building a face model of a user based on images of the face of the user and is thus not limited to a particular modeling technique. Depending upon the implementation, the face model built during step 302 may be stored locally with respect to first user computer 102 (e.g., in system memory or on a removable or non-removable storage medium that is readable by first user computer 102) or remotely with respect to first user computer 102 (e.g., on a server). The face model may be stored, for example, in the form of a binary file.

In one embodiment, face model building module 202 presents a graphical user interface (GUI) to a display associated with first user computer 102 that enables the first user to assist in the face model building process. The first user interacts with the GUI using an input device associated with first user computer 102, such as a keyboard, mouse, touch screen, or the like.

The first user may assist in the face building process, for example, by finding digital images among first user images 116 that include the face of the first user and selecting or “tagging” such digital images or a portion of such digital images. For example, in one embodiment, face model building module 202 utilizes face recognition techniques to highlight or present to the first user portions of digital images included in first user images 116 that appear to represent human faces. The first user then utilizes an input device to select those portions that represent his/her face.

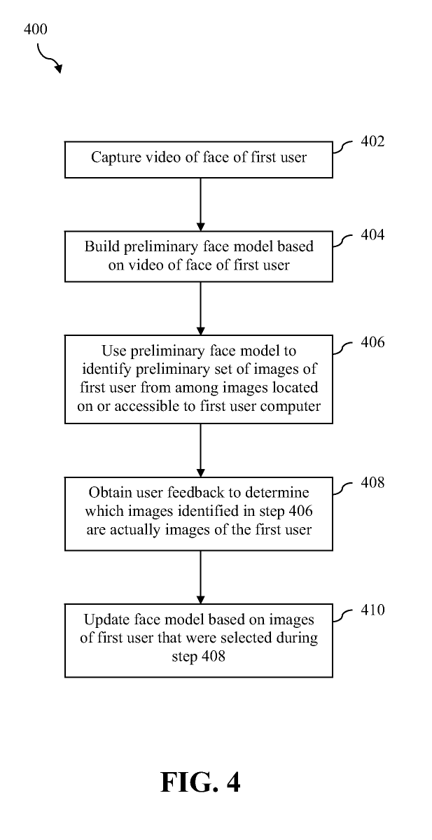

In another embodiment, a video capture device associated with first user computer 102, such as a Web camera, is used to assist in the face model building process. Depending upon the implementation, the video capture device may be an integrated part of first user computer 102 or may be connected to first user computer 102 via a suitable interface. FIG. 4 is a flowchart 400 of a face model building process in accordance with such an embodiment.

As shown in FIG. 4, the method of flowchart 400 begins at step 402 in which the video capture device captures video of the face of the first user. The video capturing process may be guided by face model building module 202 via a GUI presented to the first user. For example, face model building module 202 may present an image of a scene that is currently being captured by the video capture device so that the first user can ensure that his/her face is adequately represented within the scene. Face model building module 202 may also highlight a portion of a scene being captured by the video capture device that appears to represent the face of the first user. Such highlighting may be achieved, for example, by superimposing a box over the face of the first user in the scene when it is presented to the first user.

Face model building module 202 may also guide the video capture process by recommending to the first user that the first user look directly at the video capture device and also that the first user turn his/her face in different directions such as left, right, up and down, thereby allowing face model building module 202 to obtain as much data as possible for building a face model of the first user. Face building module 202 may also recommend to the first user that the first user make different facial expressions (such as, for example, smiling, laughing, etc.) so that face model building module 202 can obtain additional data for building the face model. The guidance may be provided to the user via a GUI or by other means including but not limited to audio prompts. Face model building module 202 may also provide an indication to the first user when certain desired views of the face of the first user have been obtained. For example, face model building module 202 may provide an indication to the first user that certain perspective views of the face of the first user have been captured or that certain facial expressions have been captured.

At step 404, face model building module 202 builds a preliminary face model based on the video images of the face of the first user that were captured during step 402. Step 404 may be performed using any of a variety of techniques known in the art or subsequently developed for building a face model of a user based on images of the face of the user and is thus not limited to a particular modeling technique.

At step 406, face model building module 202 uses the preliminary face model built during step 404 to identify a preliminary set of images of the first user from among images located on or accessible to first user computer, such as from among first user images 116. The algorithm that is used to identify images based on a face model is referred to herein as a face model classifier. In an embodiment, face building module 202 invokes face model classifier module 204 to perform step 406, although it is conceivable that face model building module 202 includes its own face model classifier for performing this step.

At step 408, face model building module 202 obtains user feedback to determine which of the images in the preliminary set of digital images identified in step 406 are actually images of the first user. In one embodiment, face model building module 202 performs this step by presenting the images identified in step 406, or a portion thereof, to the first user via a GUI. The first user then selects the images, or portions thereof, that actually show the face of the first user using an input device. For example, the first user may check a box associated with each image, or portion thereof, that shows the face of the first user, although this is merely an example.

At step 410, face model building module 202 updates the preliminary face model that was built during step 404 based on the images of the first user that were selected by the first user during step 408.

The foregoing approach to building a face model of the first user is advantageous in that it operates on both captured video images of the face of the first user as well as images of the first user that were previously stored among first user images 116, thereby ensuring that a sufficient amount of data is available to create a reasonably accurate face model even in the case where there are not many images of the first user available. Furthermore, the approach is user-friendly as it does not require the first user to search through first user images 116 to identify good candidate images for building a face model, but instead finds such images automatically based on the captured video and then presents them to the user for easy review and verification.

Although the method of flowchart 400 described above provides a particularly beneficial approach to performing step 302 of flowchart 300, it is only one example of how that step may be performed and is not intended to be limiting. Once built, the face model of the first user can be used by face model classifier module 204 to find digital images of the first user among the digital images that are stored on or accessible to first user computer 102, such as among first user images 116. Additionally, the face model can be shared as will be described below.

Returning now to the method of flowchart 300, after step 302 has been performed, face model sharing module 206 makes the face model of the first user that was built during step 302 accessible to a user of second computer 104 (referred to for the purposes of this flowchart as the “second user”). This step may be carried out in a variety of ways. For example, face model sharing module 206 may upload the face model to a remote server via network 106 such that it is accessible to a software module executing on second user computer 104. Face model sharing module 206 may then send a notification to the second user computer that indicates that the face model has been made accessible to the second user computer. For example, face model sharing module 206 may invoke e-mail module 112 to generate an e-mail addressed to the second user to indicate that the face model of the first user is available for use. The first user may then be given the option to send the e-mail or the e-mail may be sent automatically. Once sent, the e-mail is received by e-mail module 122 installed on second user computer 104. In further accordance with this example, the e-mail generated by face model sharing module 206 may also include means for installing a copy of image finding/sharing module 110 on second user computer 104. Such means may include a link to a Web site that, when activated by the second user, causes network access module 124 to connect to a server from which a copy of image finding/sharing module 110 can be downloaded.

In an alternate embodiment, face model sharing module 206 makes the face model of the first user accessible to the second user by attaching the face model directly to the e-mail that is sent to second user computer 104. In a further alternative embodiment, the face model is shared between the first user and the second user using an alternative means of communication to e-mail, such as instant messaging or the like. In such an embodiment, an e-mail module need not be installed on first user computer 102 and second computer 104.

The foregoing are only a few examples of the ways in which the face model of the first user may be made accessible to the second user in step 304. A variety of other methods may be used, including but not limiting to performing a direct file transfer between first user computer 102 and second user computer 104 via network 106 or some other communication link or saving the face model to a removable storage medium such as a CD, DVD, or flash memory drive/card and then transferring the removable storage medium to second user computer 104.

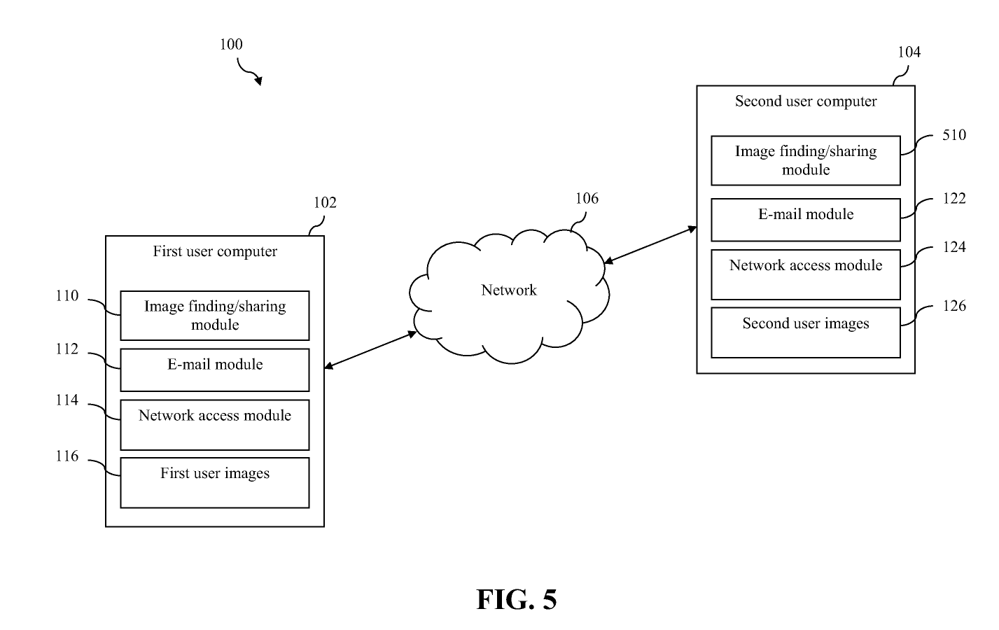

At step 306, the face model of the first user is used by second user computer 104 to find digital images of the first user that are located on and/or accessible to second user computer 104, such as among second user images 126. The performance of this step assumes that a copy of image finding/sharing module 110 has now been installed on second user computer 104. Such installation is reflected in the block diagram of FIG. 5, which shows that second user computer 104 now includes an image finding/sharing module 510. Image finding/sharing module 510 is configured to perform essentially the same functions as image finding/sharing module 110 installed on first user computer 102 and includes the same components as described above in reference to FIG. 2. The performance of step 306 is carried out by a face model classifier module included within image finding/sharing module 510.

As noted above, installation of image finding/sharing module 510 on second user computer 104 may be facilitated by including means to download and install image finding/sharing module 510 within an e-mail delivered to the second user. However, the installation of image finding/sharing module 510 on second user computer 104 may be achieved in a variety of other ways. For example, the second user may independently download image finding/sharing module 510 from a remote server using network access module 124 and install the module on second user computer 104. Alternatively, the second user may install image finding/sharing module 510 from a removable storage medium such as a CD, DVD or flash drive/card that is read by second user computer 104. Still further, image finding/sharing module 510 may comprise a part of an operating system or application that is installed on second user computer 104 during manufacturing or subsequent thereto. For example, image finding/sharing module 510 may comprise a part or plug-in module of a photo management application, such as WINDOWS LIVE™ PHOTO GALLERY, published by Microsoft Corporation of Redmond, Wash., that is installed on second user computer 104 during manufacturing or subsequent thereto. However, these examples are not intended to be limiting and still other methods may be used to install image finding/sharing module 510 on second user computer 104.

In one embodiment, step 306 involves using the face model of the first user to find an initial set of digital images of the first user that are located on and/or accessible to second user computer 104 and then presenting the initial set of digital images to the second user via a display device associated with second user computer 104. The second user may then use an input device associated with second user computer 104 to identify, or “tag”, digital images within the initial set of digital images that actually include the first user.

At step 308, an image sharing module within image finding/sharing module 510 makes the images of the first user found during step 306 accessible to the first user. This step may occur automatically without any input from the second user. However, in an alternate embodiment, the image sharing module within image finding/sharing module 510 first requests permission from the second user to share the found images. Such permission may be sought via a GUI presented on a display associated with second user computer 104 and may be granted by the second user using an input device associated with second user computer 104. In a still further embodiment, the image sharing module within image finding/sharing module 510 may also present the found images to the second user via the GUI and then allow the second user to select which of the found images he/she chooses to share.

The sharing of the found images with the first user may be achieved in a variety of ways. For example, the image sharing module within image finding/sharing module 510 may upload the images to a remote server via network 106 such that they are accessible to a software module executing on first user computer 102. If the found images already reside on a server that is accessible to first user computer 102, then the image sharing module within image finding/sharing module 510 may simply authorize the first user to access the found images. In an alternative embodiment, the image sharing module within image finding/sharing module 510 invokes e-mail module 122 and transfers the found images to the first user by e-mail.

The foregoing are only a few examples of the ways in which the found images may be shared with the first user in step 308. A variety of other methods may be used, including but not limiting to performing a direct file transfer between second user computer 104 and first user computer 102 via network 106 or some other communication link or saving the found images to a removable storage medium such as a CD, DVD, or flash memory drive/card and then transferring the removable storage medium to first user computer 102.

At step 310, the first user receives or is provided with access to the found images that were shared during step 308. As will be appreciated by persons skilled in the relevant art(s), the manner in which the first user receives or is provided with access to the found images will depend on the manner in which such images were shared during step 308. For example, if the images were shared by transferring the images to a remote server accessible to first user computer 102 or by granting access to images already available on a remote server, then step 310 will involve accessing the server. This function may be performed, for example, by image sharing module 208 alone or in conjunction with network access module 114. However, if the images were shared via e-mail, then step 310 will involve accessing the e-mail via e-mail module 112. Still other methods may be used by the first user to receive or be provided with access to the found images.

In an embodiment, image sharing module 208 provides the first user with a notification that the found images have been shared with the first user via a display associated with first user computer 102. Image sharing module 208 may also prompt the first user to determine if the first user wants to receive the shared images into first user images 116. If the first user agrees, then copies of the shared images are stored in first user images 116. In an alternate embodiment, copies of the shared images are automatically stored in first user images 116 without requiring the permission of the first user.

At step 312, every time the second user uploads new images into second user images 126, the face model classifier module within image finding/sharing module 510 will use the face model of the first user to find any newly uploaded images of the first user. Depending upon the implementation, the image sharing module within image finding/sharing module 510 will then either automatically share the images with the first user or provide the second user with the option of sharing the images, in which case the images will only be shared responsive to user input received by second user computer 104. The method by which such images are actually shared may be the same as any of the methods described above for performing step 308. Step 312 advantageously allows the first user to receive new images of himself/herself as soon as they are added to second user images 126 by the second user.

The foregoing approach to finding and sharing digital images is advantageous in that it allows first user computer 102 to build a face model of the first user that will likely be superior to any face model of the first user that could be built by second user computer 104. This is because first user computer 102 is likely to have access to more reference images of the first user than second user computer 104. In certain implementations, this is also because first user computer 102 can be used to capture video of the first user as discussed above in reference to flowchart 400 of FIG. 4. This superior face model is then shared with other user computers, such as second user computer 104. The foregoing approach to finding and sharing digital images is also advantageous in that it allows the first user to obtain digital images of himself/herself that are located in collections of digital images belonging to others, such as in second user images 126 located on or accessible to second user computer 104, in a manner that requires only a relatively small amount of effort as compared to conventional approaches. For example, the second user need not provide access to all of second user images 126 to the first user, nor is either user required to sort through such images to find images of the first user. Furthermore, the second user is not required to build his/her own face model of the first user.

The foregoing approach to finding and sharing digital images is also advantageous in that it allows a second user of second user computer 104 to search for digital images of the first user that are located on or accessible to second user computer 104 using the superior face model. In one example embodiment, image finding/sharing module 510 installed on second user computer 104 includes a search tool that, when executed, enables a user of second user computer 104 to search for digital images of the first user that are stored on or accessible to second user computer 104 based on the face model of the first user. If the second user is provided with access to multiple face models associated with multiple different users (e.g., multiple friends and/or family members) in accordance with the foregoing method, then the second user can advantageously execute searches for images of every user for which a face model has been received. For example, in one implementation in which each face model is associated with a user name, the second user may type a user name into a data entry box or select the user name from a menu of user names provided by the search tool, and the search tool will execute a search for digital images of the user identified by the user name among the digital images located on or accessible to second user computer 104 based on the face model associated with the user name.

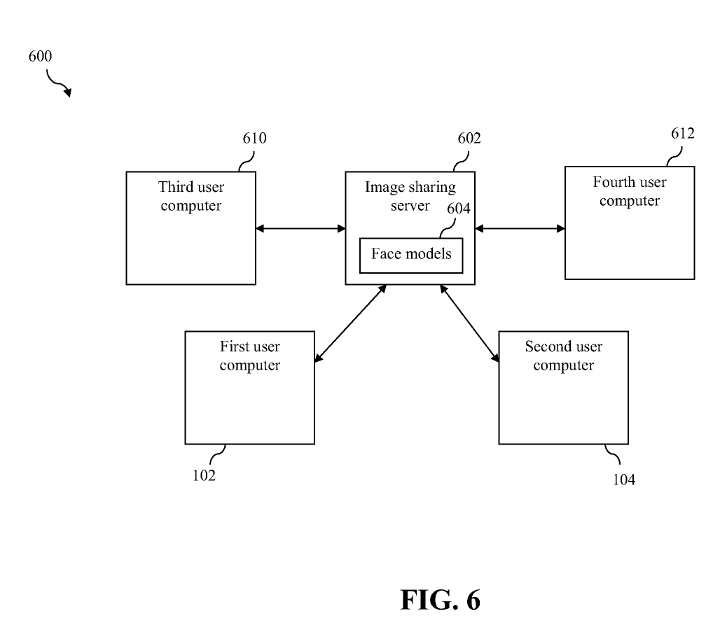

The foregoing approach to finding and sharing digital images is further advantageous is that it can be implemented across a large number of user computers, thereby facilitating image sharing among a large number of related and unrelated users in a manner that is both reliable and user-friendly. An example of this will now be described with reference to FIG. 6.

In particular, FIG. 6 is a block diagram of a system 600 that includes first user computer 102 and second user computer 104, as described above in reference to FIGS. 1, 2 and 5, as well as a third user computer 610, a fourth user computer 612, and an image sharing server 602. In the system of FIG. 6, each user computer is communicatively connected to image sharing server 602. Such connections may be formed over one or more networks, such as network 106 as described above in reference to FIG. 1.

In system 600, first user computer 102 may build a face model of a first user and the face model may be shared with second user computer 104 by uploading the face model to image sharing server 602 as described above in reference to at least one embodiment. Responsive to obtaining access to the face model of the first user, second user computer 104 may automatically find digital images of the first user among images located on or accessible to second user computer 104 and share those digital images with first user computer 102. To perform this process, an image finding/sharing module must be installed on each of first user computer 102 and second user computer 104. A second user of second user computer 104 may be guided to install the required module as part of, or in conjunction with, the process of obtaining access to the face model of the first user.

Since both first user computer 102 and second user computer 104 have the image finding/sharing module installed thereon, second user computer 104 can also build a face model of the second user and the face model may be shared with first user computer 104 by uploading the face model to image sharing server 602. Responsive to obtaining access to the face model of the second user, first user computer 102 may automatically find digital images of the second user among images located on or accessible to first user computer 102 and share those digital images with second user computer 104.

In this way, image sharing server 602 can build a library of face models 604. Such a library will grow as the first user of first user computer 102 and the second user of second user computer 104 invite more and more contacts (e.g., friends and family) to obtain their face models and to use their face models to locate images of themselves on other user computers. For example, the first user may invite a third user of third user computer 610 to obtain the face model of the first user from image sharing server 602 and use that face model to find and share images of the first user from among images stored on or accessible to third user computer 610. Likewise, the second user may invite a fourth user of fourth user computer 612 to obtain the face model of the second user from image sharing server 602 and use that face model to find and share images of the second user from among images stored on or accessible to fourth user computer 612. Consequently, the third user and the fourth user may install an image finding/sharing module on third user computer 610 and fourth user computer 612, respectively, in order to share images with the first user and the second user, respectively. The third user and the fourth user may then use the image finding/sharing module installed on third user computer 610 and fourth user computer 612, respectively, to build and share their own face models, thereby adding more face models to library of face models 604.

In further accordance with the foregoing example, image sharing server 602 may provide the face model of the first user to fourth user computer 612 and fourth user computer 612 may use the face model to locate and share images of the first user from among images stored on or accessible to fourth user computer 612 even in a scenario where the first user and the fourth user do not know each other. In this way, system 600 may actually provide users with access to images of themselves that are located in image collections belonging to people that they do not even know. This is a powerful image-finding feature. Furthermore, such a feature can advantageously be used to establish social networking connections between users that do not know each other but own or manage images of common persons.

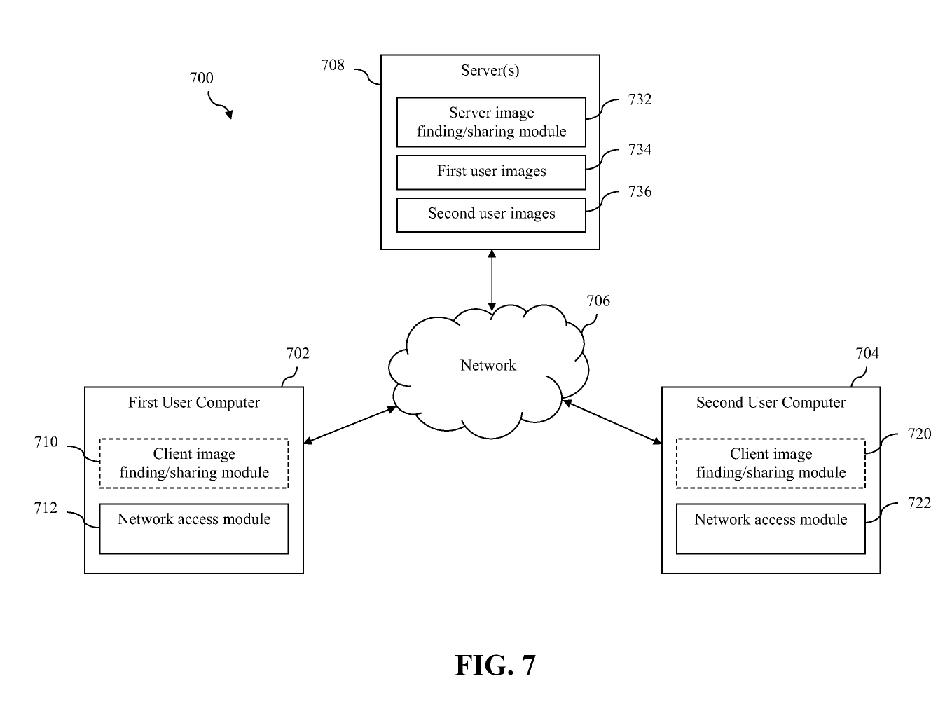

It is noted that although system 500 of FIG. 5 shows that an image finding/sharing module is installed on each of first user computer 102 and second user computer 104, in an alternate embodiment, a portion or all of the functionality provided by each image finding/sharing module may instead be provided by one or more remote servers that are communicatively connected to each user computer. An example of such an embodiment is shown in FIG. 7. In particular, FIG. 7 depicts a system 700 in which at least a portion of the image finding/sharing functionality is implemented on one or more servers 702. Such functionality is represented as a server image finding/sharing module 732 that is executed by server(s) 702. Server(s) 702 may also store first user images 734 that are accessible to a first user computer 702 via a network 706 and second user images 736 that are accessible to a second user computer 704 via network 706.

Each of first user computer 702 and second user computer 704 can invoke the features of server image finding/sharing module 732. To invoke these features, a client image finding/sharing module 710 may be installed on first user computer 702 and a client image finding/sharing module 720 may be installed on second user computer 704. Alternatively, a network access module 712 installed on first user computer 702 and a network access module 722 installed on second user computer 104 may be used to invoke the features of server image finding/sharing module 732. The features of server image finding/sharing module 732 that may be invoked by the user computers may include but are not limited to: building a face model of a user of first user computer 702 or second user computer 704, applying face models to locate desired digital images among first user images 734 or second user images 736, sharing face models of the users of first user computer 702 and 704 with other user computers, and sharing images located by server image finding/sharing module 732 with other user computers.

### II. Example Graphical User Interfaces

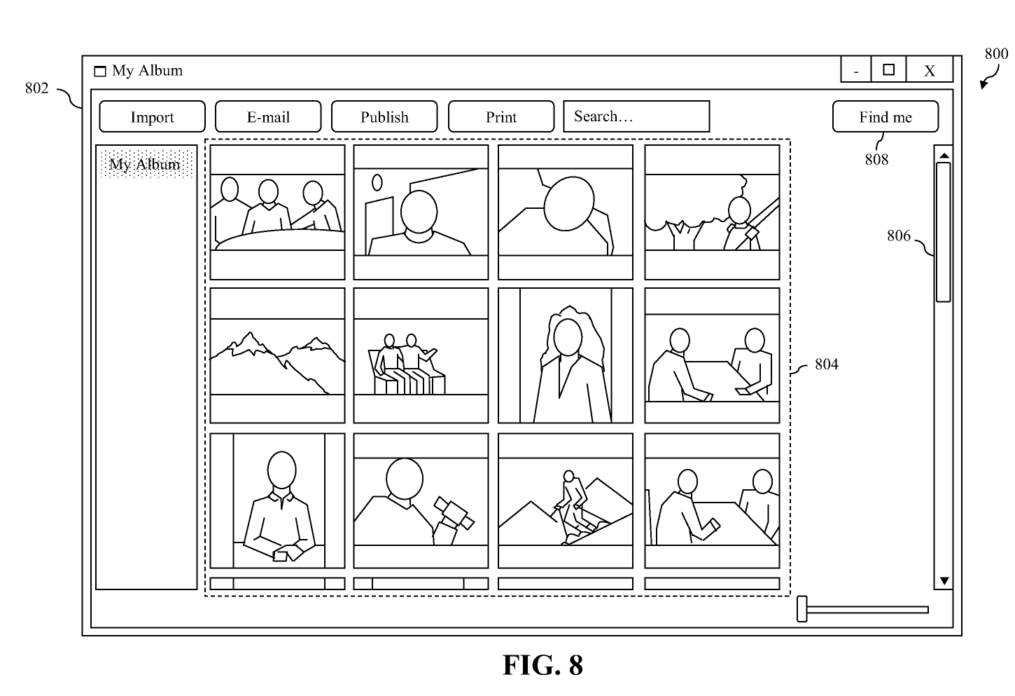

Example graphical user interfaces (GUIs) that may be used to implement a method for finding and sharing digital images of a user from among collections of digital images owned or maintained by other users will now be described in reference to FIGS. 8-13. These GUIs are presented by way of example only and are not intended to be limiting. Persons skilled in the relevant art(s) will readily appreciate that embodiments can be implemented using other GUIs or other types of interfaces entirely. Furthermore, although the GUIs of FIGS. 8-13 will be described as GUIs presented by display devices associated with first user computer 102 and second user computer 104 as described above in reference to FIGS. 1, 2 and 5, this approach has been taken merely to provide one exemplary scenario of how the finding and sharing of digital photos may occur. Persons skilled in the relevant art(s) will readily appreciate that the GUIs may be presented by other devices and/or other systems.

FIG. 8 depicts a GUI 800 that may be presented by a display device associated with first user computer 102. In one embodiment, GUI 800 comprises a GUI associated with a photo management application of which image finding/sharing module 110 is a part. For example, image finding/sharing module 110 may comprise a part or plug-in module of a photo management application, such as WINDOWS LIVE™ PHOTO GALLERY, published by Microsoft Corporation of Redmond, Wash., that is installed on first user computer 102. In accordance with such an embodiment, GUI 800 may comprise a standard window associated with the photo management application, and user interface button 808 (to be described below) may be provided to access functionality of image finding/sharing module 110.

As shown in FIG. 8, GUI 800 includes a “My Album” window 802. A portion of a collection of digital images 804 owned or managed by a user of user computer 102 is visible within window 802. A scroll bar 806 is provided to provide access to the remainder of the digital images in the collection. A number of user interface buttons are also provided within window 802, including a user interface button 808 (labeled “Find Me”) that can be used to invoke certain digital image finding/sharing features such as those described in the preceding Section. Depending upon the implementation of first user computer 102, a user may interact with or activate user interface button 808 and various other elements within window 802 by operating any one of a variety of user input devices that may be associated with first user computer 102, including but not limited to a keyboard, mouse, touch screen, or the like.

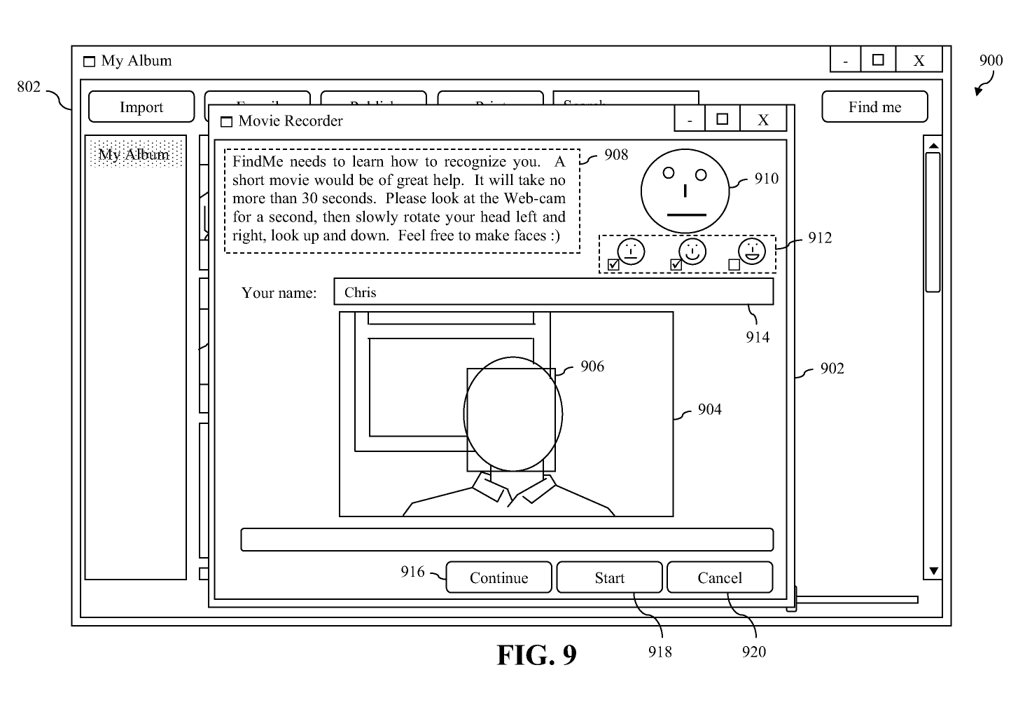

FIG. 9 depicts a GUI 900 that may be presented by a display device associated with first user computer 102 after a user has activated user interface button 808 of window 802 as previously described in reference to FIG. 8. As shown in FIG. 9, GUI 900 includes a “Movie Recorder” window 902 that has been opened on top of, or is superimposed upon, window 802. Window 902 provides an interface that facilitates capturing video for use in building a preliminary face model of a user, such as was described above in reference to flowchart 400 of FIG. 4.

To this end, window 902 includes a video display section 904 that displays a scene being captured by a video capture device that is connected to or integrated with first user computer 102. Video display section 904 provides a means by which a user can ensure that his/her face is being captured by the video capture device. A box 906 is also rendered within video display section 904. Box 906 indicates to the user the portion of the scene that is being used to build a model of the user's face. The box will be roughly aligned with the face of the user.

Window 902 also includes a text portion 908 that provides information and guidance to a user concerning the video capture process. As shown in FIG. 9, the guidance may include recommending that the user look directly at the video capture device and then turn his/her face in different directions such as left, right, up and down. This allows a face model building module installed on first user computer 102 to obtain as much data as possible for building a face model of the user. The guidance may also include recommending to the user that the user make different facial expressions (such as, for example, smiling, laughing, etc.) so that face model building module can obtain additional data for building the face model. As further shown in FIG. 9, window 902 also includes a graphic representation of a face 910 that displays an expression currently being made by the user as determined by the face model building module. Facial expression check boxes 912 are also provided to indicate when certain facial expressions have been captured by the face model building module.

Additional features provided within window 902 include a data entry box 914 in which a user may enter his/her name, a start button 918 that may be activated by a user to initiate the video capture process, a cancel button 920 that may be activated by a user to cancel the image finding/sharing process, and a continue button 916 that may be activated by a user to continue on to a subsequent step in the image finding/sharing process.

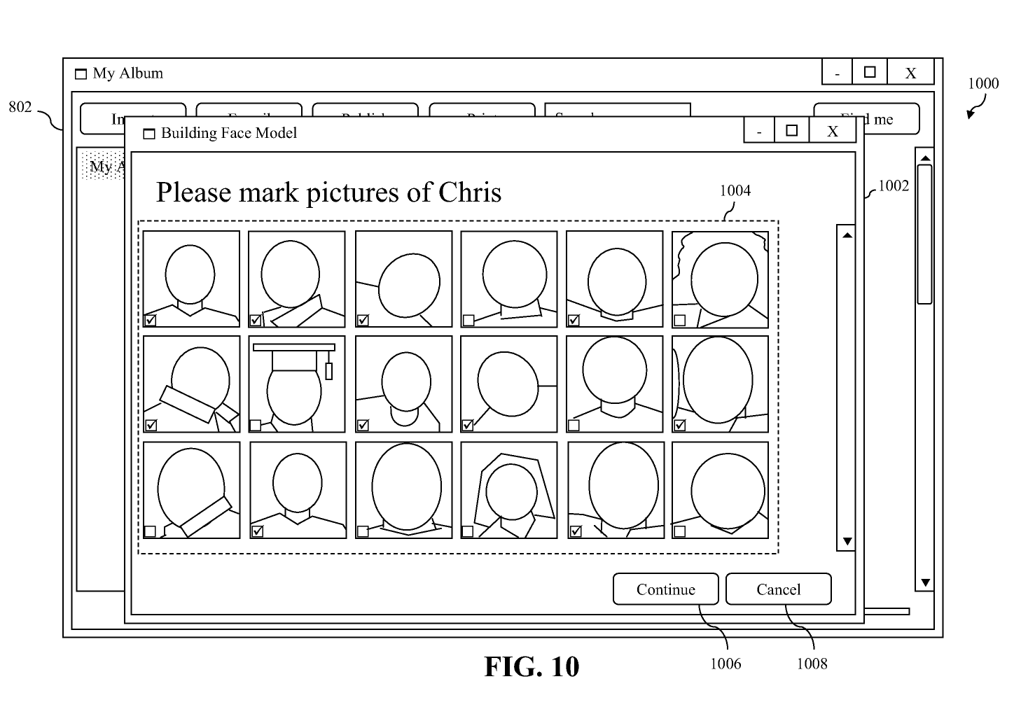

FIG. 10 depicts a GUI 1000 that may be presented by a display device associated with first user computer 102 after a user has completed a video capture process such as was previously described in reference to FIG. 9. As shown in FIG. 10, GUI 1000 includes a “Building Face Model” window 1002 that has been opened on top of, or is superimposed upon, window 802. Window 1002 displays a preliminary set of digital images 1004 of the user that was obtained from collection of digital images 804. Preliminary set of digital images 1004 may have been identified by a face model building module installed on first user computer 102 based on a preliminary face model of the user that was built based on the video capture process.

As shown in FIG. 10, each image within set 1004 is accompanied by a corresponding check box. The check box may be checked by a user to indicate to the face model building module that the corresponding image is actually an image of the user. This feature allows the user to discard any “false positives” returned by the face model building module based on the preliminary face model by simply not checking the boxes corresponding to the invalid images. The face model building module can then use this additional information to improve the face model for the user.

Additional features provided within window 1002 include a cancel button 1008 that may be activated by a user to cancel the image finding/sharing process, and a continue button 1006 that may be activated by a user to continue on to a subsequent step in the image finding/sharing process.

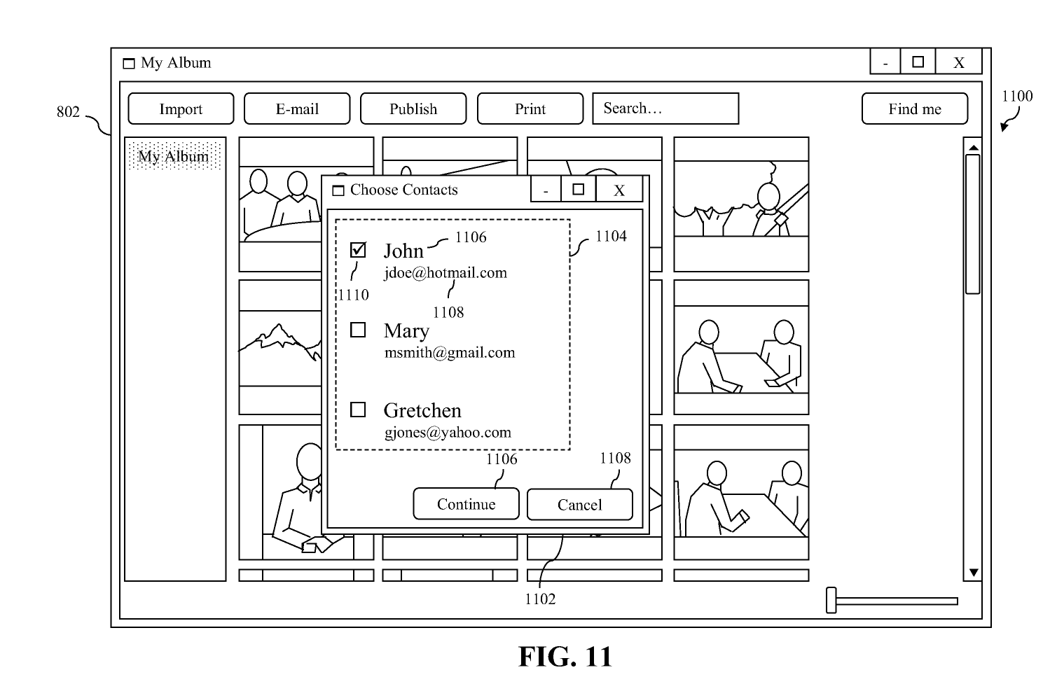

FIG. 11 depicts a GUI 1100 that may be presented by a display device associated with first user computer 102 after a face model building module has completed building a face model for the user. As shown in FIG. 11, GUI 1100 includes a “Choose Contacts” window 1102 that has been opened on top of, or is superimposed upon, window 802. Window 1102 displays a list of contacts 1104 with whom the user may share his/her face model. List 1104 may include, for example, contacts identified in an address book maintained by the user, contacts with whom the user is connected via one or more social networking applications or services, contacts from one or more instant messaging applications or services, or the like, although these examples are not intended to be limiting. Each contact in list 1104 may be identified, for example, by a nickname such as nickname 1106 and an e-mail address such as e-mail address 1108. As further shown in FIG. 11, a check box, such as check box 1110, is provided for each contact. A user may check a check box associated with a contact to indicate that his/her face model should be shared with that contact. Additional features provided within window 1102 include a cancel button 1108 that may be activated by a user to cancel the image finding/sharing process, and a continue button 1106 that may be activated by a user to continue on to a subsequent step in the image finding/sharing process.

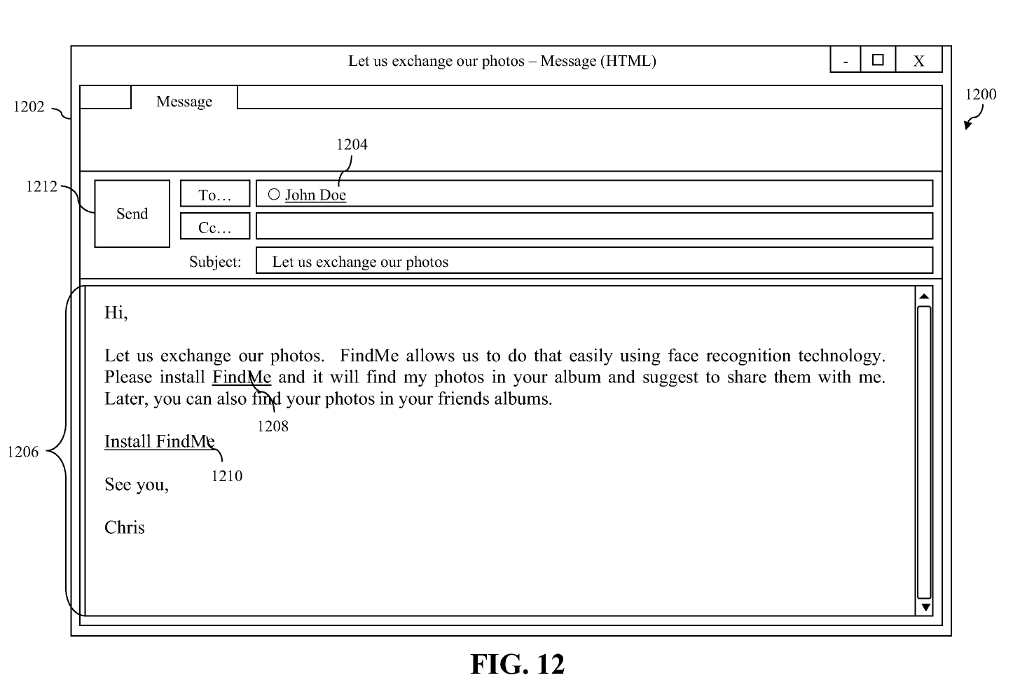

FIG. 12 depicts a GUI 1200 that shows an e-mail message that may be automatically generated by a face model sharing module installed on first user computer 102. The e-mail message may be generated by the face model sharing module to notify a selected contact that the user has shared his/her face model with the contact. The contact may be selected using, for example, GUI 1100 described above in reference to FIG. 11.

As shown in FIG. 12, the automatically-generated e-mail message is encapsulated within an e-mail application window 1202. E-mail application window 1202 includes a contact identifier 1204 that identifies the intended recipient of the e-mail. E-mail application window 1202 also includes a text section 1206. Text section 1206 includes text that explains to the intended recipient that the user would like to share images with the recipient using an image finding/sharing module (referred to in the e-mail as “FindMe”) that will find images of the user in the contact's album. Two hyperlinks 1208 and 1210 are also included in text section 1206. When either of these hyperlinks is activated by the e-mail recipient, the recipient's computer will be connected to a Web site that will permit the required software to be downloaded and installed onto the recipient's computer.

As further shown in FIG. 12, e-mail application window 1202 includes a send button 1212 that, when activated by a user, will cause the e-mail message to be sent to the intended recipient.

It is noted that in alternate embodiments, the message depicted in FIG. 12 could be sent using messaging technology other than e-mail. For example, instant messaging applications such as ICQ® (published by ICQ, LLC) or WINDOWS LIVE™ MESSENGER (published by Microsoft Corporation of Redmond, Wash.) may be used to transmit the message. However, these examples are not intended to be limiting and any suitable messaging technology may be used.

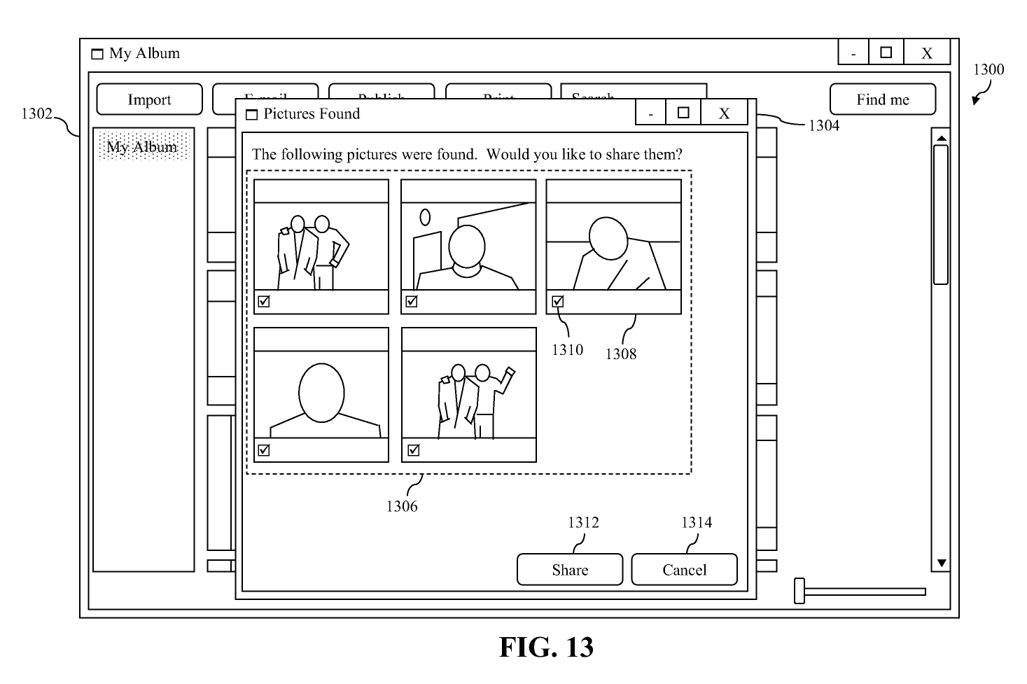

FIG. 13 depicts a GUI 1300 that may be presented by a display device associated with second user computer 104. GUI 1300 includes a “My Album” window 1302 that displays a portion of a collection of digital images owned or managed by a user of second user computer 104 and provides additional functionality that is similar to that described above in reference to “My Album” window 802 of FIG. 8.

As shown in FIG. 13, a “Pictures Found” window 1304 has been opened on top of, or superimposed upon, window 1302. Window 1304 may be displayed by an image sharing module executing on second user computer 104. Window 1304 includes a set of images 1306 of a first user that were found by a face model classifier module executing on second user computer 104 based on a face model of the first user. The face model of the first user may have been shared with second user computer 104 in a manner previously described.

Each of the images included in set 1306 is associated with a corresponding check box. For example, an image 1308 is associated with a check box 1310. A user of second user computer 104 may check each check box to indicate that a corresponding image is to be shared with the first user or un-check a check box to indicate that a corresponding image is not to be shared with the first user. In one embodiment, the image sharing module executing on second user computer 104 checks each check box by default and a user of second user computer 104 can selectively un-check check boxes associated with certain images.

Window 1304 further includes a share button 1312 and a cancel button 1314. When share button 1312 is activated by a user of second user computer 104, the checked images appearing in set 1306 will be shared with the first user. When cancel button 1314 is activated by a user of second user computer 104, the image sharing process will be aborted.

### III. Example User Computer Implementation

FIG. 14 depicts an example computer 1400 that may be used to implement any of the user computers described herein, such as first user computer 102, second user computer 102, third user computer 610, fourth user computer 612, first user computer 702, and second user computer 704, and/or any of the servers described herein, such as image sharing server 602 and server(s) 708. Computer 1400 may represent a general-purpose computing device in the form of a conventional personal computer, a mobile computer, or a workstation, for example, or computer 1400 may be a special purpose computing device. The description of computer 1400 provided herein is provided for purposes of illustration, and is not intended to be limiting. Embodiments may be implemented in further types of computer systems, as would be known to persons skilled in the relevant art(s).

As shown in FIG. 14, computer 1400 includes a processing unit 1402, a system memory 1404, and a bus 1406 that couples various system components including system memory 1404 to processing unit 1402. Processing unit 1402 may comprise one or more processors or processing cores. Bus 1406 represents one or more of any of several types of bus structures, including a memory bus or memory controller, a peripheral bus, an accelerated graphics port, and a processor or local bus using any of a variety of bus architectures. System memory 1404 includes read only memory (ROM) 1408 and random access memory (RAM) 1410. A basic input/output system 1412 (BIOS) is stored in ROM 1408.

Computer 1400 also has one or more of the following drives: a hard disk drive 1414 for reading from and writing to a hard disk, a magnetic disk drive 1416 for reading from or writing to a removable magnetic disk 1418, and an optical disk drive 1420 for reading from or writing to a removable optical disk 1422 such as a CD ROM, DVD ROM, or other optical media. Hard disk drive 1414, magnetic disk drive 1416, and optical disk drive 1420 are connected to bus 1406 by a hard disk drive interface 1424, a magnetic disk drive interface 1426, and an optical drive interface 1428, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1430, one or more application programs 1432, other program modules 1434, and program data 1436. Application programs 1432 or program modules 1434 may include, for example, any of the software modules described herein, such as any of the software modules described in reference to FIGS. 1, 2 and 5, as well as logic for performing any of the various method steps described herein, such as logic for performing any of the method steps of flowcharts 300 or 400.

A user may enter commands and information into the computer 1400 through input devices such as keyboard 1438 and pointing device 1440. Other input devices (not shown) may include a microphone, joystick, game controller, scanner, or the like. These and other input devices are often connected to the processing unit 1402 through a serial port interface 1442 that is coupled to bus 1406, but may be connected by other interfaces, such as a parallel port, game port, or a universal serial bus (USB).

A monitor 1444 or other type of display device is also connected to bus 1406 via an interface, such as a video adapter 1446. In addition to the monitor, computer 1400 may include other peripheral output devices (not shown) such as speakers and printers.

Computer 1400 is connected to a network 1448 (e.g., a local area network or wide area network such as the Internet) through a network interface or adapter 1450, a modem 1452, or other means for establishing communications over the network. Modem 1452, which may be internal or external, is connected to bus 1406 via serial port interface 1442.

As used herein, the terms “computer program medium” and “computer-readable medium” are used to generally refer to media such as the hard disk associated with hard disk drive 1414, removable magnetic disk 1418, removable optical disk 1422, as well as other media such as flash memory cards, digital video disks, random access memories (RAMs), read only memories (ROM), and the like.

As noted above, computer programs and modules (including application programs 1432 and other program modules 1434) may be stored on the hard disk, magnetic disk, optical disk, ROM, or RAM. Such computer programs may also be received via network interface 1450 or serial port interface 1442. Such computer programs, when executed or loaded by an application, enable computer 1400 to implement features of embodiments discussed herein. Accordingly, such computer programs represent controllers of the computer 1400.

Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
building a face model of a first user using a first user computer, wherein the face model is built based on digital images of the first user stored on or accessible to the first user computer; and
making the face model of the first user accessible to a second user computer for use by the second computer in finding digital images of the first user stored on or accessible to the second user computer.

2. The method of claim 1, further comprising:
obtaining access by the first computer to digital images of the first user that were found by the second user computer using the face model of the first user.

3. The method of claim 1, wherein building the face model of the first user using the first user computer comprises:
presenting a graphical user interface on a display associated with the first user computer by which a user can identify the digital images of the first user stored on or accessible to the first user computer.

4. The method of claim 1, wherein building the face model of the first user using the first user computer comprises:
capturing video images of the first user via a video capture device associated with the first user computer; and
building the face model based on the captured video images.

5. The method of claim 4, wherein building the face model based on the captured video images comprises:
building a preliminary face model based on the captured video images;
identifying a preliminary set of digital images of the first user stored on or accessible to the first user computer based on the preliminary face model;
receiving user input that identifies which of the digital images in the preliminary set of digital images actually represents the first user; and
updating the preliminary face model based on the identified digital images.

6. The method of claim 1, wherein providing the second user computer with access to the face model of the first user comprises:
uploading the face model of the first user to a remote server that is accessible by the second user computer.

7. The method of claim 1, further comprising:
sending a notification from the first user computer to the second user computer that indicates that the face model of the first user has been made accessible to the second user computer.

8. The method of claim 1, wherein sending the notification from the first user computer to the second user computer comprises sending an e-mail from the first user computer to the second user computer and wherein the e-mail includes a means for downloading and installing software on the second user computer that enables the second user computer to use the face model of the first user to find digital images of the first user stored on or accessible to the second user computer.

9. The method of claim 1, further comprising:
obtaining access by the first user computer to a face model of a second user that was built on the second user computer using digital images stored on or accessible to the second user computer; and
using the face model of the second user by the first user computer to find digital images of the second user that are stored on or accessible to the first user computer.

10. A method comprising:
obtaining access by a second user computer to a face model of a first user that was built on a first user computer using digital images stored on or accessible to the first user computer; and
using the face model of the first user by the second user computer to find digital images of the first user that are stored on or accessible to the second user computer.

11. The method of claim 10, wherein using the face model of the first user by the second user computer to find digital images of the first user that are stored on or accessible to the second user computer comprises:
executing a search tool on the second user computer that enables a user of the second user computer to search for digital images of the first user that are stored on or accessible to the second user computer based on the face model of the first user.

12. The method of claim 10, further comprising:
making digital images of the first user that are found among the digital images stored on or accessible to the second user computer accessible to the first user computer.

13. The method of claim 12, wherein making the digital images of the first user that are found among the digital images stored on or accessible to the second user computer accessible to the first user computer comprises:
automatically making the digital images of the first user that are found among the digital images stored on or accessible to the second user computer accessible to the first user computer.

14. The method of claim 12, wherein making the digital images of the first user that are found among the digital images stored on or accessible to the second user computer accessible to the first user computer comprises:
making the digital images of the first user that are found among the digital images stored on or accessible to the second user computer accessible to the first user computer responsive to user input received by the second user computer.

15. The method of claim 10, further comprising:
responsive to determining that new digital images have been stored on or made accessible to the second user computer:
using the face model of the first user by the second user computer to find digital images of the first user among the new digital images, and
making digital images of the first user that are found among the new digital images accessible to the first user computer.

16. The method of claim 15, wherein making the digital images of the first user that are found among the new digital images accessible to the first user computer comprises:
automatically making the digital images of the first user that are found among the new digital images accessible to the first user computer or making the digital images of the first user that are found among the new digital images accessible to the first user computer responsive to user input received by the second user computer.

17. A system comprising:
a first user computer configured to build a face model of a first user, wherein the face model of the first user is built based on digital images of the first user stored on or accessible to the first user computer; and
a second user computer configured to obtain access to the face model of the first user and to use the face model of the first user to find digital images of the first user stored on or accessible to the second user computer.

18. The system of claim 17, wherein the second user computer is further configured to provide access to the first user computer to digital images of the first user that were found by the second user computer using the face model of the first user.

19. The system of claim 17, wherein the second user computer is further configured to build a face model of a second user, wherein the face model of the second user is built based on digital images of the second user stored on or accessible to the second user computer; and
wherein the first user computer is further configured to obtain access to the face model of the second user and to use the face model of the second user to find digital images of the second user stored on or accessible to the first user computer.

20. The system of claim 19, wherein the first user computer is further configured to provide access to the second user computer to digital images of the second user that were found by the first user computer using the face model of the second user.
